(19) United States
(12) Patent Application Publication
(10) Pub. No.: US 2026/0279806 A1
(43) Pub. Date: Sep. 17, 2026

(54) POROUS CARBON MATERIAL AND PREPARATION METHOD THEREOF, SILICON-CARBON MATERIAL, AND APPLICATIONS THEREOF

(71) Applicant: Ningde Amperex Technology Limited, Fujian (CN)

(72) Inventor: Min JIANG, Fujian (CN)

(73) Assignee: Ningde Amperex Technology Limited, Fujian (CN)

(21) Appl. No.: 19/564,209

(22) Filed: Mar. 12, 2026

(30) Foreign Application Priority Data
Mar. 12, 2025 (CN) 202510292885.5

(51) Int. Cl. H01M 4/587; C01B 32/205; C01B 32/348; H01M 4/02; H01M 4/36; H01M 10/0567; H01M 10/0569

(52) U.S. Cl. CPC H01M 4/587; C01B 32/205; C01B 32/348; H01M 4/366; H01M 10/0567; H01M 10/0569; C01P 2002/70; C01P 2004/32; C01P 2004/80; C01P 2006/40; H01M 2004/027; H01M 2300/0034

(57) ABSTRACT

A porous carbon material having a sphericity of a, where 0.7≤a≤0.97; the porous carbon material includes potassium element; and based on a mass of the porous carbon material, a mass proportion of the potassium element is b ppm, where 1≤b≤2998.

### CROSS-REFERENCE TO RELATED APPLICATION

The present application claims priority to Chinese Patent application No. 202510292885.5 filed in the China National Intellectual Property Administration on Mar. 12, 2025, the entire content of which is hereby incorporated by reference.

### TECHNICAL FIELD

This application pertains to the field of battery material technology and specifically relates to a porous carbon material and a preparation method thereof, a silicon-carbon material, and applications thereof.

### BACKGROUND

Secondary batteries (such as lithium-ion batteries) achieve the conversion between chemical energy and electrical energy through the synergistic action of a positive electrode, a negative electrode, an electrolyte, and a separator, with their performance critically dependent on the ionic conduction velocity and structural stability of electrode materials. Among negative electrode materials, due to a high specific capacity up to 3579 mAh/g, silicon is considered as an ideal candidate to break through conventional graphite negative electrodes (372 mAh/g). However, volume swelling (>300%) of silicon caused by lithiation/dilithiation reactions during charging and discharging easily leads to electrode pulverization, detachment of active materials, and repeated rupture of solid electrolyte interface (SEI) films, thus significantly shortening the cycle life.

To mitigate the above issues, a silicon-carbon material is prepared by embedding a silicon material in a carbon matrix, where the high conductivity and mechanical buffering characteristics of a carbon phase can be used to buffer the swelling of the silicon material to some extent, thereby improving the overall stability. However, the existing composite structure of the silicon-carbon material still faces the issues such as insufficient silicon-carbon interface compatibility and obstructed lithium-ion diffusion paths, affecting the ionic conductivity of secondary batteries. Particularly in electrodes with a high compacted density, the above defects exacerbate electrode polarization and cause rapid capacity decay in secondary batteries. Therefore, how a secondary battery with high ionic conductivity and swelling buffering performance is constructed to achieve a synergistic improvement in energy density and cycle stability of the secondary battery is a critical issue that urgently needs to be addressed in the art.

### SUMMARY

In view of this, this application provides a porous carbon material and a preparation method thereof, a silicon-carbon material, and applications thereof, allowing a secondary battery to have both high ionic conductivity and swelling buffering performance, thereby allowing the secondary battery to exhibit excellent electrochemical performance.

According to a first aspect, this application provides a porous carbon material, where a sphericity of the porous carbon material is a, where 0.7≤a≤0.97; the porous carbon material includes potassium element; and based on a mass of the porous carbon material, a mass proportion of the potassium element is b ppm, where 1≤b≤2998. In this application, doping the porous carbon material with the potassium element can improve the ionic conductivity of the porous carbon material and improve the initial coulombic efficiency of the silicon-carbon material. However, the strong etching capability of the potassium element can easily damage the structure of the porous carbon material, causing local structural defects, reducing the elastic modulus of the porous carbon material, and increasing the internal stress difference in the silicon-carbon material during swelling. In this application, controlling the sphericity of the porous carbon material and utilizing the isotropy of the spherical shape can balance the stress during swelling, thereby improving the elastic modulus of the porous carbon material and the swelling suppression of the silicon-carbon material, allowing the silicon-carbon material to withstand a higher compacted density, and helping to improve the energy density and initial coulombic efficiency of a secondary battery. Therefore, in this application, optimizing the structure and elemental composition of the porous carbon material allows the sphericity feature and the mass proportion of the potassium element to synergistically cooperate, thereby improving both the ionic conductivity and swelling suppression of the secondary battery.

In some embodiments, the porous carbon material satisfies at least one of the following conditions:

$$50 \leq a \times b \leq 2800 ; \qquad ( 1 )$$

$$0.75 \leq a \leq 0.95 ; or \qquad ( 2 )$$

$$10 \leq b \leq 997 . \qquad ( 3 )$$

Based on the above solution, the ionic conductivity and swelling suppression of the secondary battery can be further improved.

In some embodiments, in XRD of the porous carbon material, a full width at half maximum of a diffraction peak of a (002) crystal plane is FWHM°, where 0.4≤FWHM≤1.5. In this application, controlling the full width at half maximum FWHM° of the (002) crystal plane diffraction peak in an XRD pattern of the porous carbon material to satisfy 0.4≤FWHM≤1.5 allows the porous carbon material of this application to have an appropriate degree of graphitization. A crystal structure with carbon atoms arranged orderly is conducive to improving the ionic conductivity of the secondary battery; and in combination with the mass proportion of the potassium element and the sphericity feature, the crystal structure can further improve the initial coulombic efficiency of the silicon-carbon material and improve both the ionic conductivity and swelling suppression of the secondary battery.

According to a second aspect, this application provides a preparation method of the above porous carbon material. The preparation method includes the following steps:
step S1, heating a carbon precursor in an inert gas to a temperature ranging from 600° C. to 1400° C. for carbonization treatment to obtain a carbonized material, where a carbonization treatment duration is 2 h to 8 h, and a sphericity of the carbon precursor is 0.7 to 0.97;
step S2, mixing the carbonized material with a pore-forming agent at a mass ratio of 1:(1 to 3), then placing the resulting mixture in a rotary furnace, and heating the resulting mixture in an inert gas to T° C. for activation treatment to obtain an activated material, where 700≤T≤1000, an activation treatment duration is 2 h to 20 h, and the pore-forming agent includes at least one of potassium hydroxide, potassium carbonate, potassium bicarbonate, or potassium chloride; and
step S3, sequentially washing the activated material with water and acid to obtain a porous carbon material, where a molar concentration of hydrogen ions in an acid solution used for the acid washing is 0.1 mol/L to 3.0 mol/L.

In this application, simultaneously controlling the type of the pore-forming agent, the mass ratio of the carbonized material to the pore-forming agent, and the molar concentration of hydrogen ions in the acid solution used for the acid washing can control the mass proportion of the potassium element in the porous carbon material to cooperate with the sphericity feature of the carbon precursor, so that a porous carbon material with an appropriate structure and elemental composition is obtained. This is conducive to improving both the ionic conductivity and swelling suppression of a secondary battery when the porous carbon material is used in the secondary battery.

According to a third aspect, this application further provides a silicon-carbon material including a porous carbon material and a silicon material located within pores of the porous carbon material, where the porous carbon material includes any one of the above porous carbon materials or a porous carbon material obtained by the above preparation method.

According to a fourth aspect, this application provides a secondary battery including a positive electrode, a negative electrode, and an electrolyte, where the negative electrode includes a negative electrode current collector and a negative electrode material layer disposed on at least one surface of the negative electrode current collector; the negative electrode material layer includes the above silicon-carbon material; and based on a mass of the negative electrode material layer, a mass proportion of the potassium element is C ppm, where 1≤C≤100.

In some embodiments, the electrolyte includes fluoroethylene carbonate and ethylene carbonate, where based on a mass of the electrolyte, a mass proportion of fluoroethylene carbonate is D₁%, and a mass proportion of ethylene carbonate is D₂%, where 0.5≤D₁/D₂≤2. The electrolyte including fluoroethylene carbonate (FEC) and ethylene carbonate (EC) facilitates the formation of a flexible solid electrolyte interface film (SEI film). Controlling the mass proportions of the two to satisfy the above relationship allows the electrolyte to synergistically cooperate with the silicon-carbon material of this application, thereby further improving the initial coulombic efficiency and swelling suppression of the secondary battery.

In some embodiments, the electrolyte satisfies at least one of the following conditions:

$$0.5 \leq {D}_{1} / {D}_{2} \leq 2 ; \qquad ( 1 )$$

$$5 \leq {D}_{1} \leq 20 ; or \qquad ( 2 )$$

$$5 \leq {D}_{2} \leq 20 . \qquad ( 3 )$$

Based on the above solution, fluoroethylene carbonate and ethylene carbonate can cooperate more effectively, further improving the initial coulombic efficiency and swelling suppression of the secondary battery.

In some embodiments, the electrolyte includes ethyl sulfonyl fluoride; and based on a mass of the electrolyte, a mass proportion of ethyl sulfonyl fluoride is E %, where 0.1≤E≤2. Ethyl sulfonyl fluoride can decompose to produce fluorine-containing anions. Controlling the mass proportion of ethyl sulfonyl fluoride to allow the electrolyte to contain fluorine-containing anions at an appropriate concentration facilitates the combination of the fluorine-containing anions with the potassium element in the silicon-carbon material to form an SEI film containing KF, improving the ion transport capability of the SEI film, and helping to improve the flexibility of the SEI film. The combination of the mass proportion of ethyl sulfonyl fluoride with the mass proportion of the potassium element can improve the structural stability of the silicon-carbon material and reduce the swelling rate of the negative electrode during cycling, thereby improving the initial coulombic efficiency and swelling suppression of the secondary battery.

In some embodiments, 0.5≤C/E≤100. Controlling the mass proportion of ethyl sulfonyl fluoride in the electrolyte and the mass proportion of the potassium element in the negative electrode material layer to satisfy the above relationship can improve the synergistic effect of the two, thereby further improving the initial coulombic efficiency and swelling suppression of the secondary battery.

According to a fifth aspect, this application provides an electronic apparatus including any one of the above secondary batteries.

### DETAILED DESCRIPTION

To make the objectives, technical solutions, and advantages of this application clearer, this application is further described in detail below with reference to some embodiments. It should be understood that the specific embodiments described herein are merely used to explain this application and are not intended to limit this application.

During the study of a silicon-carbon material, the inventor has found that the ionic conductivity of the silicon-carbon material is limited by the porosity of a porous carbon material, the dispersion uniformity of silicon particles, and the strength of interfacial chemical bonding, while the swelling suppression capability is closely related to the mechanical modulus of the porous carbon material and the size distribution of silicon particles. In the existing silicon-carbon composite material, silicon particle agglomeration and disordered carbon layer structures result in increased local ion transport impedance, and the anisotropic stress distribution of the porous carbon material is less likely to effectively constrain the swelling of a silicon phase. Based on this, this application provides a porous carbon material. A silicon-carbon material with both high ionic conductivity and swelling buffering capability is constructed by optimizing structures of the porous carbon material and the silicon-carbon material through the design of material morphology and composition.

In this application, a sphericity of the porous carbon material is a, where 0.7≤a≤0.97; the porous carbon material includes potassium element; and based on a mass of the porous carbon material, a mass proportion of the potassium element is b ppm, where 1≤b≤2998. In this application, doping the porous carbon material with the potassium element can improve the ionic conductivity of the porous carbon material and improve the initial coulombic efficiency of the silicon-carbon material. However, the potassium element can easily damage the structure of the porous carbon material, reducing the elastic modulus and compressive strength of the porous carbon material. In this application, controlling the sphericity of the porous carbon material and utilizing the isotropy of the spherical shape can balance the stress during swelling, thereby improving the elastic modulus of the porous carbon material and the swelling suppression of the silicon-carbon material, allowing the silicon-carbon material to withstand a higher compacted density, and helping to improve the energy density and initial coulombic efficiency of a secondary battery. Therefore, in this application, the synergistic cooperation of the sphericity feature and the mass proportion of the potassium element in the porous carbon material can improve both the ionic conductivity and swelling suppression of the secondary battery.

In some embodiments, the porous carbon material satisfies: 50≤a×b≤2800. For example, the value of a×b may be 50, 330, 620, 660, 1130, 1480, 1780, 2030, 2420, 2690, 2800, or a value within a range defined by any two of these values. Controlling the mass proportion of the potassium element in the porous carbon material and the sphericity of the porous carbon material to satisfy the above relationship can further facilitate the synergistic effect of the two, thereby further improving the ionic conductivity and swelling suppression of the secondary battery.

In some embodiments, 0.7≤a≤0.97, preferably 0.75≤a≤0.95. For example, a may be 0.7, 0.72, 0.76, 0.79, 0.80, 0.84, 0.87, 0.92, 0.93, 0.97, or a value within a range defined by any two of these values. Controlling the sphericity of the porous carbon material to meet the above range can reduce the stress caused by the swelling of the silicon material, improving the elastic modulus and structural stability of the porous carbon material, and helping to further improve the ionic conductivity and swelling suppression of the secondary battery.

In some embodiments, 1≤b≤2998, preferably 10≤b≤997. For example, b may be 1, 7, 10, 60, 230, 300, 390, 560, 610, 740, 820, 950, 1000, 1170, 1330, 1570, 1870, 1910, 2180, 2410, 2640, 2980, 2998, or a value within a range defined by any two of these values. Based on the above solution, the graphitization degree and elastic modulus of the porous carbon material can be balanced, further improving the ionic conductivity and swelling suppression of the secondary battery.

In some embodiments, in XRD of the porous carbon material, a full width at half maximum of a diffraction peak of a (002) crystal plane is FWHM°, where 0.4≤FWHM≤1.5. In this application, controlling the full width at half maximum FWHM° of the (002) crystal plane diffraction peak in an XRD pattern of the porous carbon material to satisfy 0.4≤FWHM≤1.5 allows the porous carbon material of this application to have an appropriate degree of graphitization. A crystal structure with carbon atoms arranged orderly is conducive to improving the ionic conductivity of the secondary battery; and in combination with the mass proportion of the potassium element and the sphericity feature, the crystal structure can further improve the initial coulombic efficiency of the silicon-carbon material and improve both the ionic conductivity and swelling suppression of the secondary battery.

This application further provides a preparation method of the above porous carbon material. The preparation method includes the following steps:

Step S1: Heat a carbon precursor in an inert gas to a temperature ranging from 600° C. to 1400° C. for carbonization treatment to obtain a carbonized material, where a carbonization treatment duration is 2 h to 8 h, and a sphericity of the carbon precursor is 0.7 to 0.97.

Step S2: Mix the carbonized material with a pore-forming agent at a mass ratio of 1:(1 to 3), then place the resulting mixture in a rotary furnace, and heat the resulting mixture in an inert gas to T° C. for activation treatment to obtain an activated material, where 700≤T≤1000, an activation treatment duration is 2 h to 20 h, and the pore-forming agent includes at least one of potassium hydroxide, potassium carbonate, potassium bicarbonate, or potassium chloride.

Step S3: Sequentially wash the activated material with water and acid to obtain a porous carbon material, where a molar concentration of hydrogen ions in an acid solution used for the acid washing is 0.1 mol/L to 3.0 mol/L.

In this application, simultaneously controlling the type of pore-forming agent, the mass ratio of the carbonized material to the pore-forming agent, and the molar concentration of hydrogen ions in the acid solution used for the acid washing can control the mass proportion of the potassium element in the porous carbon material to cooperate with the sphericity feature of the carbon precursor, so that a porous carbon material with an appropriate sphericity structure and elemental composition is obtained. This is conducive to improving both the ionic conductivity and swelling suppression of a secondary battery when the porous carbon material is used in the secondary battery.

The porous carbon material obtained by the preparation method of this application satisfies: a sphericity of the porous carbon material is a, where 0.7≤a≤0.97; the porous carbon material includes potassium element; and based on a mass of the porous carbon material, a mass proportion of the potassium element is b ppm, where 1≤b≤2998. During the activation treatment, the potassium element has a catalytic graphitization effect on the porous carbon material, improving the orderliness of a carbon framework, reducing side reactions between silicon and carbon elements, and improving the reversible lithium intercalation capacity of the silicon-carbon material. Controlling the mass proportion of the potassium element in the porous carbon material to satisfy 1≤b≤2998 can improve the graphitization degree of the porous carbon material, reducing a full width at half maximum FWHM value of a (002) plane peak, gradually improving the ionic conductivity, and reducing the formation of a surface SEI film, thereby reducing electrolyte consumption, and ultimately improving the initial coulombic efficiency of the porous carbon material and the silicon-carbon material. In addition, controlling the sphericity of the porous carbon material to satisfy 0.7≤a≤0.97 can uniformly disperse internal stresses of the material, improving the elastic modulus of the material, reducing fragmentation of the silicon-carbon material, and improving the resistance to swelling of silicon grains. In addition, the above sphericity can guarantee contact between the silicon-carbon material and a binder as well as a conductive agent, improving the initial coulombic efficiency and cycling swelling suppression of the secondary battery.

In particular, when the mass proportion of the potassium element is controlled to satisfy 10≤b≤997, excessive pores formed by the pore-forming agent in the porous carbon material can be further reduced, improving the thickness and uniformity of the carbon wall of the porous carbon material, improving the elastic modulus of the porous carbon material, and helping to improve the swelling suppression of the secondary battery. On this basis, when the sphericity satisfies 0.75≤a≤0.95, internal stresses in the silicon-carbon material and contact with the conductive agent and the binder can be further balanced, improving both the initial coulombic efficiency and cycling swelling suppression of the secondary battery.

In some embodiments, the carbonization treatment includes: placing the carbon precursor in an oven, introducing an inert gas to expel air, then heating to 600° C. to 1400° C., and holding the temperature for 2 h to 8 h to obtain the carbonized material. The carbonized material may then be cooled for subsequent processing. This application has no special requirement for the selection of the carbon precursor, as long as the requirements of this application can be met. For example, the carbon precursor may be selected from at least one of a biomass precursor, a sugar precursor, a synthetic resin precursor, or an asphalt precursor. A sphericity of the carbon precursor is 0.7 to 0.97, for example, 0.7, 0.72, 0.76, 0.78, 0.83, 0.85, 0.89, 0.91, 0.95, 0.97, or a value within a range defined by any two of these values. Controlling the sphericity of the carbon precursor can obtain a porous carbon material with an appropriate sphericity.

In some embodiments, the activation treatment includes: mixing the carbonized material and the pore-forming agent, placing the resulting mixture in a rotary furnace, introducing an inert gas to expel air, heating to 700° C. to 1000° C., and holding the temperature for 2 h to 20 h to obtain the activated material. The activated material may then be cooled for subsequent processing. In this application, the pore-forming agent may be selected from at least one of potassium hydroxide, potassium carbonate, potassium bicarbonate, or potassium chloride, particularly at least one of potassium hydroxide, potassium carbonate, or potassium bicarbonate, or a mixture of at least one of potassium hydroxide, potassium carbonate, or potassium bicarbonate with potassium chloride. During activation, the above pore-forming agent can etch the carbonized material to achieve pore formation while introducing the potassium element to improve the graphitization degree of the porous carbon material. However, local defects are easily caused in the activation process, reducing the elastic modulus of the porous carbon material. Controlling an amount ratio of the carbonized material to the pore-forming agent to cooperate with the sphericity feature can improve both the graphitization degree and elastic modulus of the porous carbon material.

In some embodiments, the activated material is first washed with water and then cleaned with an acid solution in which a molar concentration of hydrogen ions is 0.1 mol/L to 3 mol/L, so that excess potassium element can be removed. The acid solution may be a hydrochloric acid, where a molar ratio of the hydrochloric acid to the activator is 1:(1 to 1.3). The excess potassium element is removed, so that a mass proportion of residual potassium element in the porous carbon material can be precisely controlled, helping the potassium element to better improve the structure in the porous carbon material, improving the lithium-ion diffusion and velocity, reducing lattice stress during intercalation/deintercalation.

In this application, the prepared porous carbon material may be subjected to filtration and drying for subsequent use.

This application further provides a silicon-carbon material including a porous carbon material and a silicon material located within pores of the porous carbon material, where the porous carbon material includes any one of the above porous carbon materials or a porous carbon material obtained by the above preparation method.

The silicon-carbon material of this application may be prepared by a method including the following steps:
placing the porous carbon material in a rotary furnace, introducing an inert atmosphere and heating to 450° C. to 600° C., then introducing a silicon-containing gas for chemical vapor deposition, holding the temperature for 2 h to 8 h, and finally stopping the introduction of the silicon-containing gas to obtain a silicon-carbon material, followed by cooling to room temperature.

This application has no special requirement for the inert gas used during preparation, as long as the objectives of this application can be met. For example, the inert gas may be at least one of nitrogen, argon, or helium.

This application further provides a secondary battery including a positive electrode, a negative electrode, and an electrolyte.

### Secondary Battery

The secondary battery of this application is not particularly limited. Based on the type of an electron transport material, the secondary battery is classified into various categories. For example, when the electron transport material is lithium (Li, including ions), the secondary battery is a lithium-ion battery. When the electron transport material is sodium (Na, including ions), the secondary battery is a sodium-ion battery. The following describes this application by taking a secondary battery as an example in conjunction with some embodiments of this application. It should be noted that in the specific embodiments of this application, a secondary battery is used as an example of the secondary battery to explain this application, but the secondary battery of this application is not limited to a secondary battery.

According to an embodiment of this application, the secondary battery may include a cell and an electrolyte. The cell may include a packaging material and an electrode assembly disposed inside the packaging material, and the electrolyte may fill the internal space formed by the packaging material. The packaging material can protect the electrode assembly from external impacts and prevent electrolyte leakage to the outside. Based on the shape of the packaging material, the cell may be classified into a prismatic cell, a cylindrical cell, or a pouch cell.

The electrode assembly includes a positive electrode, a negative electrode, a separator, and other components known in the art for secondary batteries, with no limitations imposed on these other components in this application. The separator may be positioned between the positive electrode and the negative electrode.

This application has no particular limitation on the preparation method of the secondary battery. For example, the preparation method may include the following steps: stacking the positive electrode, the separator, and the negative electrode in sequence, performing operations of winding or folding the resulting stack as needed to obtain an electrode assembly, placing the electrode assembly into the packaging material, injecting the electrolyte into the packaging material, and sealing to obtain a secondary battery.

### Positive Electrode

In this application, there is no particular limitation on the positive electrode, as long as the objectives of this application can be achieved. The positive electrode includes a positive electrode current collector and a positive electrode material layer disposed on at least one surface of the positive electrode current collector. The “positive electrode material layer disposed on at least one surface of the positive electrode current collector” means that the positive electrode material layer may be located on one surface of the positive electrode current collector along its thickness direction or on both surfaces of the positive electrode current collector along its thickness direction. It should be noted that the “surface” here may refer to an entire region of the surface of the positive electrode current collector or a partial region of the surface of the positive electrode current collector, with no particular limitation in this application, as long as the objectives of this application can be achieved.

This application has no particular limitation on the type, size, and shape of the positive electrode current collector, as long as the positive electrode current collector does not cause chemical changes in the cell and has conductivity. For example, the positive electrode current collector may use materials such as stainless steel, aluminum, nickel, titanium, calcined carbon, or a material for performing surface treatment on aluminum or stainless steel surfaces with carbon, nickel, titanium, or silver. In this application, the positive electrode current collector may further include a non-metallic element. For example, the non-metallic element includes at least one of fluorine, phosphorus, boron, chlorine, silicon, or sulfur.

The positive electrode current collector may have an appropriate thickness as needed. Although not particularly limited, the positive electrode current collector may have a thickness in a range of 1 μm to 500 μm, 1 μm to 300 μm, 1 μm to 100 μm, 1 μm to 50 μm, or 1 μm to 20 μm.

Unless otherwise specified, the terms thickness (or height), width, and length used in this application refer to average values and can be measured using measuring instruments capable of measuring thickness (or height), width, and length, respectively, according to methods known in the art.

The positive electrode current collector may have fine concave and convex structures formed on its surface to further enhance adhesion with the positive electrode material layer. For example, the form of the positive electrode current collector may be one or more selected from a film, a sheet, a foil, a net, a porous body, foam, or a non-woven fabric.

In this application, the positive electrode material layer includes a positive electrode active material. This application has no particular limitation on the type of positive electrode active material, as long as the objectives of this application can be achieved. For example, the positive electrode active material may include at least one of lithium nickel cobalt manganese oxide (LiNi_{0.90}Co_{0.05}Mn_{0.05}O₂ (NCM955), NCM811, NCM622, NCM523, or NCM111), lithium nickel cobalt aluminate, lithium iron phosphate, lithium vanadium phosphate, lithium cobalt phosphate, lithium manganese phosphate, lithium manganese iron phosphate, lithium-rich manganese-based materials, lithium cobalt oxide (LiCoO₂), lithium iron silicate, lithium vanadium silicate, lithium cobalt silicate, lithium manganese silicate, spinel-type lithium manganese oxide, spinel-type lithium nickel manganese oxide, or lithium titanate. In this application, the positive electrode active material may further include a non-metallic element. For example, the non-metallic element includes at least one of fluorine, phosphorus, boron, chlorine, silicon, or sulfur. In this application, there is no particular limitation on the thicknesses of the positive electrode current collector and the positive electrode material layer, as long as the objectives of this application can be achieved.

In some embodiments, the positive electrode material layer may further include a positive electrode binder. This application has no particular limitation on the type of the positive electrode binder, as long as the objectives of this application can be achieved. For example, the positive electrode binder may include but is not limited to at least one of polyvinylidene fluoride, polytetrafluoroethylene, polyolefins, sodium carboxymethyl cellulose, lithium carboxymethyl cellulose, modified polyvinylidene fluoride, modified styrene-butadiene rubber (SBR), polyolefin esters, polyolefin alcohols, polyacrylic acid, or polyurethane. In some embodiments, the polyolefin binder includes at least one of polyethylene or polypropylene.

In some embodiments, the positive electrode material layer may further include a conductive agent. This application has no particular limitation on the type of the conductive agent in the positive electrode material layer, as long as the objectives of this application can be achieved. In some exemplary embodiments, the conductive agent includes: a carbon-based material, for example, graphite such as natural graphite or artificial graphite, carbon black such as acetylene black, Ketjen black, channel black, furnace black, lamp black, or thermal black, or carbon fiber; a conductive polymer, for example, a polyphenylene derivative; a conductive metal oxide, for example, zinc oxide or titanium oxide; a conductive whisker for example, potassium titanate; or a mixture formed by any combination of these materials.

In this application, the positive electrode material layer may be formed by applying a positive electrode slurry on at least one surface of the positive electrode current collector and drying with rolling performed after drying as needed. The positive electrode slurry includes the positive electrode active material, the positive electrode binder, and the conductive agent. In addition, the positive electrode slurry may further include a solvent. This application has no particular limitation on the type of solvent, as long as the objectives of this application can be achieved. For example, the solvent may use N-methyl-2-pyrrolidone.

This application has no particular limitation on mass ratios of the positive electrode active material, conductive agent, and positive electrode binder in the positive electrode material layer, and persons skilled in the art can select according to actual needs, as long as the objectives of this application can be achieved. These mass ratios may use known mass ratios.

### Negative Electrode

This application has no particular limitation on the negative electrode, as long as the objectives of this application can be achieved. For example, the negative electrode includes a negative electrode current collector and a negative electrode material layer disposed on at least one surface of the negative electrode current collector. In this application, the negative electrode material layer may be disposed on one surface of the negative electrode current collector along its thickness direction or on both surfaces of the negative electrode current collector along its thickness direction. It should be noted that the “surface” here may refer to an entire region of the negative electrode current collector or a partial region of the negative electrode current collector, with no particular limitation in this application, as long as the objectives of this application can be achieved.

This application has no particular limitation on the type, size, and shape of the negative electrode current collector, as long as the negative electrode current collector does not cause chemical changes in the cell and has conductivity. For example, the negative electrode current collector may use materials such as stainless steel, copper, nickel, titanium, calcined carbon, or a material for performing surface treatment on copper or stainless steel surfaces with carbon, nickel, titanium, or silver.

The negative electrode current collector may have an appropriate thickness as needed. Although not particularly limited, the negative electrode current collector may have a thickness in a range of 1 μm to 500 μm, 1 μm to 300 μm, 1 μm to 100 μm, 1 μm to 50 μm, 1 μm to 20 μm, or 5 μm to 10 μm.

The negative electrode current collector may have fine concave and convex structures formed on its surface to further enhance adhesion with the negative electrode material layer. For example, the form of the negative electrode current collector may be one or more selected from a film, a sheet, a foil, a net, a porous body, foam, or a non-woven fabric.

The negative electrode material layer of this application includes a negative electrode active material, and the negative electrode active material includes the above silicon-carbon material. Based on a mass of the negative electrode material layer, a mass proportion of the potassium element is C ppm, where 1≤C≤100. For example, C may be 1, 8, 12, 24, 41, 49, 66, 77, 86, 95, 100, or a value within a range defined by any two of these values. Controlling the mass proportion of the potassium element in the negative electrode material layer to meet the above range can further improve the ionic conductivity and swelling suppression of the secondary battery.

In some embodiments, the negative electrode active material may further include other materials, for example, including but not limited to: a carbon material such as graphite (artificial graphite, natural graphite, or graphitized carbon fiber) or amorphous carbon; metals capable of alloying with lithium, such as Si, Al, Sn, Pb, Zn, Bi, In, Mg, Ga, Cd, Si alloys, Sn alloys, or Al alloys, or alloys formed by the metals and lithium; metal oxides capable of doping or dedoping lithium, such as SiO_{β} (0<β≤2), SnO, SnO₂, vanadium oxide, lithium vanadium oxide, or alloys formed by the metal oxides and lithium; or composites containing the metals and carbon materials, such as Si—C composites or Sn—C composites; or lithium titanate with a spinel structure, such as lithiated TiO₂—Li₄Ti₅O₁₂; and any one or a mixture of two or more of these materials may be used. Specifically, the carbon material may use low-crystallinity carbon and high-crystallinity carbon. Representative low-crystallinity carbon includes soft carbon and hard carbon. Examples of high-crystallinity carbon may include amorphous, plate-like, flake-like, spherical, or fibrous natural graphite or artificial graphite, primary graphite, pyrolytic carbon, mesophase pitch-based carbon fiber, carbon microspheres (mesophase carbon microspheres), mesophase pitch, and high-temperature calcined carbon such as petroleum and coal-based coke (coke derived from petroleum or coal tar pitch).

The negative electrode material layer of this application further includes a negative electrode binder. This application has no particular limitation on the type of the negative electrode binder, as long as the objectives of this application can be achieved. For example, the negative electrode binder may include but is not limited to at least one selected from polyvinylidene fluoride (PVDF), polyvinyl alcohol, styrene-butadiene rubber (SBR), polyethylene oxide, carboxymethyl cellulose (CMC), hydroxypropyl cellulose, cellulose acetate, diacetyl cellulose, cellulose acetate butyrate, cellulose acetate propionate, cyanoethyl pullulan, cyanoethyl polyvinyl alcohol, cyanoethyl cellulose, cyanoethyl sucrose, pullulan, polymethyl polybutyl methacrylate, acrylate, polyacrylonitrile, polyvinylpyrrolidone, polyvinyl acetate, ethylene-vinyl acetate copolymer, polyarylate, polyvinyl chloride, carboxylated polyvinyl chloride, polyvinyl fluoride, polymers containing ethylene oxide, polyurethane, polytetrafluoroethylene, polyethylene, polypropylene, polyacrylic acid, acrylic acid (ester)-modified styrene-butadiene rubber, epoxy resin, or nylon.

This application has no particular limitation on the type of the conductive agent in the negative electrode material layer, as long as the objectives of this application can be achieved. In some exemplary embodiments, the conductive agent includes: a carbon-based material, for example, graphite such as natural graphite or artificial graphite, carbon black such as acetylene black, Ketjen black, channel black, furnace black, lamp black, or thermal black, or carbon fiber; a metal-based material such as metal powder or metal fiber of copper, nickel, aluminum, or silver; a conductive polymer such as a polyphenylene derivative; a conductive metal oxide such as zinc oxide or titanium oxide; a conductive whisker such as potassium titanate; or a mixture formed by any combination of these materials.

This application has no particular limitation on mass ratios of the negative electrode active material, negative electrode conductive agent, and negative electrode binder in the negative electrode material layer, and persons skilled in the art can select according to actual needs, as long as the objectives of this application can be achieved. These mass ratios may use known mass ratios.

In this application, the negative electrode material layer may be formed by applying a negative electrode slurry on at least one surface of the negative electrode current collector and drying, with rolling performed after drying as needed. The negative electrode slurry includes the negative electrode active material and the negative electrode binder, and may further include a conductive agent as needed. In addition, the negative electrode slurry may further include a solvent. This application has no particular limitation on the type of the solvent in this application, as long as the objectives of this application can be achieved. For example, the solvent may use deionized water.

### Separator

The separator of this application is a film used to prevent short circuits between the positive electrode and the negative electrode while allowing the passage of an electron transport material. This application has no particular limitation on the separator, as long as the objectives of this application can be achieved. For example, the material of the separator may include but is not limited to at least one of polyolefins (PO) mainly including polyethylene (PE) and polypropylene (PP), polyester (for example, a polyethylene terephthalate (PET) film), cellulose, polyimide (PI), polyamide (PA), spandex, or aramid. The type of separator may include at least one of a woven film, a non-woven film, a microporous film, a composite film, a rolled film, or a spun film.

According to some embodiments of this application, the separator may include a substrate layer and a surface treatment layer. The substrate layer may be a non-woven fabric, film, or composite film with a porous structure. The material of the substrate layer may include at least one of polyethylene, polypropylene, polyethylene terephthalate, or polyimide. Optionally, a polypropylene porous film, a polyethylene porous film, a polypropylene non-woven fabric, a polyethylene non-woven fabric, or a polypropylene-polyethylene-polypropylene porous composite film may be used.

Optionally, the surface treatment layer is disposed on at least one surface of the substrate layer, and the surface treatment layer may be a polymer layer, an inorganic layer, or a layer formed by a mixture of the polymer and the inorganic material. For example, the inorganic layer includes inorganic particles and a binder. This application has no particular limitation on the inorganic particles. For example, the inorganic particles may include at least one of aluminum oxide, silicon oxide, magnesium oxide, titanium oxide, hafnium dioxide, tin oxide, cerium dioxide, nickel oxide, zinc oxide, calcium oxide, zirconium oxide, yttrium oxide, silicon carbide, boehmite, aluminum hydroxide, magnesium hydroxide, calcium hydroxide, or barium sulfate. This application has no particular limitation on the binder. For example, the binder may be at least one of the positive electrode binder or negative electrode binder described above. The polymer layer includes a polymer. This application has no particular limitation on the polymer. For example, the polymer may include at least one of polyamide, polyacrylonitrile, acrylate polymer, polyacrylic acid, polyacrylate, polyvinylpyrrolidone, polyvinyl ether, polyvinylidene fluoride, or poly(vinylidene fluoride-hexafluoropropylene). In this application, there is no particular limitation on the thickness of the separator, as long as the objectives of this application can be achieved. For example, the thickness of the separator may be 5 μm to 500 μm.

### Electrolyte

In this application, the electrolyte is a medium that facilitates the movement of the electron transport material to enable smooth electrochemical reactions at the positive electrode and the negative electrode. The electrolyte may use an organic liquid electrolyte, an inorganic liquid electrolyte, a gel polymer electrolyte, and a molten inorganic electrolyte that are commonly used, but is not limited thereto. A solid electrolyte such as a gel polymer electrolyte may alternatively be used to replace the electrolyte. A battery using a solid electrolyte is typically referred to as a solid-state battery or an all-solid-state battery. The liquid electrolyte (an electrolyte solution) typically includes a non-aqueous solvent and a lithium salt.

In some embodiments, the electrolyte includes fluoroethylene carbonate and ethylene carbonate; and based on a mass of the electrolyte, a mass proportion of fluoroethylene carbonate is D₁%, and a mass proportion of ethylene carbonate is D₂%, where 0.5≤D₁/D₂≤2. In this application, the electrolyte includes fluoroethylene carbonate (FEC) and ethylene carbonate (EC), and a proportional relationship between the mass proportions of FEC and EC is controlled, allowing for a cooperation with a high dielectric constant of EC. The induction of an appropriate amount of potassium element in the silicon-carbon material allows EC to form a solid electrolyte interface film (SEI film) with high ionic conductivity on the surface of the silicon-carbon material. However, a large number of inorganic components in the SEI film may affect the elasticity of the SEI film, which is not conducive to the adaptation of the SEI film to volume changes in the silicon-carbon material. The electrolyte includes FEC, so that the elasticity of the SEI film can be further improved. Controlling the proportional relationship between the mass proportions of FEC and EC helps the electrolyte form an SEI film with both high ionic conductivity and elasticity on the surface of the silicon-carbon material containing an appropriate amount of potassium element, thereby further improving the initial coulombic efficiency and swelling suppression of the secondary battery.

In some embodiments, 0.5≤D₁/D₂≤2; and preferably, 0.75≤D₁/D₂≤1.8. For example, the value of D₁/D₂ may be 0.5, 0.7, 0.9, 1.1, 1.3, 1.4, 1.6, 1.8, 1.9, 2, or a value within a range defined by any two of these values. When the above relationship is satisfied, fluoroethylene carbonate and ethylene carbonate can cooperate more effectively, further improving the initial coulombic efficiency and swelling suppression of the secondary battery.

In some embodiments, 5≤D₁≤20. For example, the value of D₁ may be 5, 8, 9, 10, 13, 15, 16, 17, 20, or a value within a range defined by any two of these values. Controlling the mass proportion of fluoroethylene carbonate to meet the above range can further improve the initial coulombic efficiency and swelling suppression of the secondary battery.

In some embodiments, 5≤D₂≤20. For example, the value of D₂ may be 5, 8, 9, 10, 13, 15, 16, 17, 20, or a value within a range defined by any two of these values. Controlling the mass proportion of ethylene carbonate to meet the above range can further improve the initial coulombic efficiency and swelling suppression of the secondary battery.

In some embodiments, the electrolyte includes ethyl sulfonyl fluoride; and based on a mass of the electrolyte, a mass proportion of ethyl sulfonyl fluoride is E %, where 0.1≤E≤2. For example, E may be 0.1, 0.3, 0.5, 0.6, 0.8, 1.2, 1.3, 1.6, 1.7, 1.8, 2, or a value within a range defined by any two of these values. Ethyl sulfonyl fluoride (EtSO₂F) can decompose to produce fluorine-containing anions. The electrolyte including fluorine-containing anions at an appropriate concentration facilitates the combination of the fluorine-containing anions with the potassium element in the silicon-carbon material to form an SEI film containing KF, improving the ion transport capability of the SEI film, and helping to improve the flexibility of the SEI film. The combination of ethyl sulfonyl fluoride with the potassium element can improve the structural stability of the silicon-carbon material and reduce the swelling rate of the negative electrode during cycling, thereby improving the initial coulombic efficiency and swelling suppression of the secondary battery.

In some embodiments, 0.5≤C/E≤100. For example, the value of C/E may be 0.5, 1, 4, 9, 20, 29, 42, 55, 67, 75, 84, 95, 100, or a value within a range defined by any two of these values. Controlling the mass proportion of ethyl sulfonyl fluoride in the electrolyte and the mass proportion of the potassium element in the negative electrode material layer to satisfy the above relationship can improve the synergistic effect of the two, thereby further improving the initial coulombic efficiency and swelling suppression of the secondary battery.

According to some embodiments of this application, the lithium salt may include but is not limited to at least one of lithium hexafluorophosphate (LiPF₆), lithium tetrafluoroborate (LiBF₄), lithium difluorophosphate (LiPO₂F₂), lithium bis(trifluoromethanesulfonyl)imide {LiN(CF₃SO₂)₂ or LiTFSI}, lithium bis(fluorosulfonyl)imide {LiN(SO₂F)₂ or LiFSI}, lithium bis(oxalato)borate {LiB(C₂O₄)₂ or LiBOB}, lithium difluoro (oxalato)borate {LiBF₂(C₂O₄) or LiDFOB}, LiNO₃, LiClO₄, LiB(C₆H₅)₄, LiCH₃SO₃, LiCF₃SO₃, LiC(SO₂CF₃)₃, Li₂SiF₆, lithium bis(trifluoromethanesulfonyl)imide (LiTFSI), or lithium difluoroborate. This application does not limit the content of the lithium salt in the electrolyte, as long as the objectives of this application can be achieved.

This application has no particular limitation on the non-aqueous solvent. For example, the non-aqueous solvent may include but is not limited to at least one of a carbonate compound, a carboxylate compound, an ether compound, or another organic solvent. The carbonate compound may include but is not limited to at least one of a linear carbonate compound, a cyclic carbonate compound, or a fluorinated carbonate compound. The linear carbonate compound may include but is not limited to at least one of dimethyl carbonate (DMC), diethyl carbonate (DEC), dipropyl carbonate, methyl propyl carbonate, ethyl propyl carbonate, or ethyl methyl carbonate (EMC). The cyclic carbonate compound may include but is not limited to at least one of propylene carbonate (PC), butylene carbonate, or vinylethylene carbonate. The fluorinated carbonate compound may include but is not limited to at least one of 1,2-difluoroethylene carbonate, 1,1-difluoroethylene carbonate, 1,1,2-trifluoroethylene carbonate, 1,1,2,2-tetrafluoroethylene carbonate, 1-fluoro-2-methylethylene carbonate, 1-fluoro-1-methylethylene carbonate, 1,2-difluoro-1-methylethylene carbonate, 1,1,2-trifluoro-2-methylethylene carbonate, or trifluoromethylethylene carbonate. The carboxylate compound may include but is not limited to at least one of methyl formate, methyl acetate, ethyl acetate, n-propyl acetate, tert-butyl acetate, methyl propionate, ethyl propionate, propyl propionate, γ-butyrolactone, decanolide, valerolactone, or caprolactone. The ether compound may include but is not limited to at least one of 1,3-dioxolane (DOL), ethylene glycol dimethyl ether (1,2-dimethoxyethane, DME), dibutyl ether, tetraethylene glycol dimethyl ether, diethylene glycol dimethyl ether, 1,2-diethoxyethane, 1-ethoxy-1-methoxyethane, 2-methyltetrahydrofuran, or tetrahydrofuran.

### Electronic Apparatus

This application provides an electronic apparatus including the above secondary battery. The electronic apparatus of this application is not particularly limited and may be any electronic apparatus known in the prior art. For example, the electronic apparatus may include but is not limited to a notebook computer, a pen-input computer, a mobile computer, an e-book reader, a portable phone, a portable fax machine, a portable copier, a portable printer, a head-mounted stereo headset, a video recorder, a liquid crystal display television, a portable cleaner, a portable CD player, a mini-disc player, a transceiver, an electronic notebook, a calculator, a memory card, a portable recorder, a radio, a backup power source, a motor, an automobile, a motorcycle, a power-assisted bicycle, a bicycle, a lighting fixture, a toy, a gaming console, a clock, an electric tool, a flashlight, a camera, a large household battery, and a lithium-ion capacitor.

### Measurement Methods

The physical properties mentioned in this application can be measured using the following methods, and the physical properties in the following examples and comparative examples were measured using these methods.

### XRD Test:

An XRD ray powder diffractometer (model: BRUKER D8 Advance) was used, and a Cu target (λ=1.54178 Å) was used as a target material for testing. A porous carbon material was used as a sample under test; the sample under test was sieved through a 200-mesh sieve; the sieved powder was taken and placed into a sample reservoir; then the surface was flattened; and excess powder at the edge was removed. The prepared sample under test was placed into the XRD ray powder diffractometer, the sample under test was tested, and an XRD pattern was collected. Then, the collected XRD pattern was analyzed to obtain a full width at half maximum of a (002) crystal plane diffraction peak.

### Test of Ionic Conductivity (Dmt)

First, a silicon-carbon material from an example or a comparative example was used as a negative electrode active material to prepare a suspension containing a negative electrode active material, a conductive agent (carbon nanotubes (CNT)), and a binder (polymethyl acrylate), where a mass ratio of the negative electrode active material, the conductive agent, and the binder was 8:1:1. Then, the suspension was applied to a metal current collector copper foil to form a single-layer particle electrode (SLPE). After application of the suspension, the electrode was dried using infrared radiation.

Then, a porous polyethylene film with a thickness of 12 μm was selected as a separator; the prepared SLPE was assembled with a lithium metal counter electrode and the separator into a button battery; and an electrolyte from Example 1-1 was added, such that the SLPE, the lithium metal counter electrode, and the separator were immersed in the electrolyte.

Finally, the button battery after electrolyte injection was subjected to electrochemical impedance spectroscopy (EIS) test; a solid diffusion overpotential (ηs) was separated through an intersection of a linear extrapolation and a potential curve; and an ionic conductivity (Dmt) was ultimately calculated.

### Test of Mass Proportion of Potassium Element

### Test of Mass Proportion of Potassium Element in Porous Carbon Material:

1.25 g of a porous carbon material or negative electrode material powder was added to 50 ml of deionized water, stirred at 80° C. for 4 h, and filtered to obtain a filtrate. A PXBJ-287L portable ion meter was used for testing. A calibrated potassium ion electrode was placed into the filtrate; a molar concentration reading of potassium ions in the filtrate was read; and calculation was performed to obtain the mass proportion of the potassium element relative to the porous carbon material or the negative electrode material layer.

### Test of Initial Coulombic Efficiency

Electrode preparation: A silicon-carbon material from an example or a comparative example was used as a negative electrode active material. The negative electrode active material, a conductive agent (carbon nanotubes (CNT)), a binder (polymethyl acrylate), and a thickener (sodium carboxymethyl cellulose (CMC)) were stirred and mixed well in deionized water at a weight ratio of 95.7:1.5:1.8:1 to form a uniform negative electrode slurry. The negative electrode slurry was uniformly applied to a negative electrode current collector copper foil, followed by drying and cold pressing to form a negative electrode active material layer. Then, cutting and tab welding were performed to obtain a negative electrode plate.

Button battery assembly: Lithium metal was used as a counter electrode; a lithium metal plate with a diameter of 18 mm and a thickness of 0.6 mm, a separator (a porous polyethylene film with a thickness of 12 μm), and a negative electrode plate from each of examples and comparative examples (cut into discs with a diameter of 18 mm for use) were assembled and stacked in sequence; the corresponding electrolyte from the example or comparative example was added; and the resulting product was encapsulated in a positive and negative electrode button-type stainless steel shell to obtain a button battery.

At 25° C., the button battery was left standing for 4 h, discharged to 5 mV at a constant current of 0.02 C, and then left standing for 5 min. Then, the button battery was charged to 2.0 V at a constant current of 0.02 C. A first-cycle charge capacity and a first-cycle discharge capacity were recorded. Initial coulombic efficiency=first-cycle charge capacity/first-cycle discharge capacity.

### Sphericity Test

A ZEISS-SEM (sigma-02-33) scanning electron microscope was used to observe particle samples of a negative electrode active material; particles of 20 porous carbon materials were randomly selected; and perimeter-equivalent diameters and area-equivalent diameters of the particles of the porous carbon material particles were calculated. Sphericity of each porous carbon material=perimeter-equivalent diameter/area-equivalent diameter. An arithmetic average of the sphericities of the 20 porous carbon materials was calculated as the sphericity of the porous carbon material.

### Test of Cycling Swelling Performance

A lithium-ion battery was left standing in a constant temperature chamber at 25° C.±1° C. for 30 minutes, charged to 4.35 V at a constant current of 0.5 C, then charged to 0.025C at a constant voltage of 4.35 V, left standing for 5 minutes, and then discharged to 3.0 V at 0.5 C. This process was one charge-discharge cycle. An initial thickness H₀ of the lithium-ion battery was recorded. Then, 600 cycles were performed according to the above cycle process. A thickness H₁ after the 600th cycle was recorded.

Cycling swelling rate=(H₁−H₀)/H₀×100%.

The following describes the solution of this application by using a lithium-ion battery as an example with reference to specific embodiments. Unless otherwise specified, the raw materials used in the following examples are all commercially available products, and apparatuses or devices used are purchased from conventional commercial channels.

### Example 1-1

### Preparation Method of Silicon-Carbon Material:

Step S1: A carbon precursor resin with a sphericity of 0.95 was heated to 1100° C. in argon for carbonization treatment to obtain a carbonized material, where a carbonization treatment duration was 5 h.

Step S2: The carbonized material was mixed with a pore-forming agent potassium carbonate at a mass ratio of 1:0.4, and the resulting mixture was placed in a rotary furnace and heated to 850° C. in argon for activation treatment to obtain an activated material, where an activation treatment duration was 6 h.

Step S3: The activated material was sequentially washed with water and a hydrochloric acid to obtain a porous carbon material. A molar concentration of hydrogen ions in the hydrochloric acid was 0.5 mol/L, and a molar ratio of the hydrochloric acid to potassium carbonate was 1:1.

Step S4: The porous carbon material was placed in a rotary furnace, argon was introduced, and the material was heated to 550° C. Subsequently, a silicon-containing gas was introduced for chemical vapor deposition, and the temperature was maintained for 4 h. Finally, the introduction of the silicon-containing gas was stopped, a silicon-carbon material was obtained and then cooled to room temperature.

### Preparation of Negative Electrode:

The silicon-carbon material was mixed with artificial graphite at a mass ratio of 10:90, and a negative electrode active material was obtained. The negative electrode active material (95 wt %), conductive carbon black (0.5 wt %), polymethyl acrylate (3.5 wt %), and carboxymethyl cellulose (1 wt %) were mixed, then deionized water was added, and the resulting mixture was stirred well to prepare a negative electrode slurry. The negative electrode slurry was uniformly applied on one surface of a copper foil, and then drying was performed. Then, the same steps were repeated on the other surface of the copper foil to obtain a negative electrode plate with two surfaces coated with negative electrode material layers. The coated copper foil was dried, pressed, and then cut into a specified size; and tabs were welded to obtain a negative electrode.

### Preparation of Positive Electrode:

Lithium cobalt oxide (97 wt %), conductive carbon black (1.5 wt %), and polyvinylidene fluoride (1.5 wt %) were mixed in N-methylpyrrolidone, and a positive electrode slurry was prepared. The positive electrode slurry was uniformly applied on one surface of an aluminum foil, and then drying was performed. Then, the coating steps were repeated on the other surface of the aluminum foil, resulting in a positive electrode plate with two surfaces coated with positive electrode material layers. The coated aluminum foil was dried, pressed, and cut into a specified size; and tabs were welded to obtain a positive electrode.

Preparation of separator: A polyethylene (PE) microporous film with a thickness of 7 μm was selected as a separator.

### Preparation of Electrolyte:

In an argon atmosphere glovebox with a water content of less than 10 ppm, ethyl propionate (EP) and propyl propionate (PP) were mixed at a mass ratio of 3:1 to obtain a base solvent. Then, ethylene carbonate, fluoroethylene carbonate, 1,3-propane sultone, and lithium hexafluorophosphate were added to the base solvent and mixed well to obtain an electrolyte. Based on a mass of the electrolyte, a mass proportion of lithium hexafluorophosphate was 12.5%, a mass proportion of ethylene carbonate was 12%, a mass proportion of fluoroethylene carbonate was 9%, and a mass proportion of 1,3-propane sultone was 2%. The remainder was the base solvent.

### Preparation of Battery:

The positive electrode, the separator, and the negative electrode were stacked in sequence, such that the separator was located between the positive electrode and the negative electrode to provide isolation. The resulting stack was wound to obtain an electrode assembly. The electrode assembly was placed in an outer package aluminum-plastic film and baked, followed by electrolyte injection, vacuum sealing, standing, formation, shaping, capacity testing, and other processes, to obtain a lithium-ion battery.

### Examples 1-2 to 1-10 and Comparative Examples 1-1 to 1-3

These examples differed from Example 1-1 only in that the sphericity of the porous carbon material, the mass proportion of the potassium element, and the full width at half maximum of the (002) crystal plane diffraction peak were adjusted according to Table 1. The specific adjustment parameters and performance test results were shown in Table 1 below. In examples or comparative examples in Table 1, a carbon precursor with higher sphericity was selected to improve the sphericity of the porous carbon material, and the mass ratio of the carbonized material to the pore-forming agent was reduced to increase the mass proportion of the potassium element in the porous carbon material, so that the full width at half maximum of the (002) crystal plane diffraction peak was reduced. In Comparative Example 1-2, no potassium carbonate was added in step S2.

TABLE 1

| | | | | Full width | | | |
|---|---|---|---|---|---|---|---|
| | | Mass | | at half | | | |
| | | proportion b | | maximum | | Initial | |
| | | of potassium | | FWHM of | Ionic | coulombic | Cycling |
| | Sphericity | element | | (002) plane | conductivity | efficiency | swelling |
| No. | a | (ppm) | a × b | (°) | (×10⁻⁸ S/cm) | (%) | rate (%) |
| Example 1-1 | 0.95 | 398 | 378.1 | 1.25 | 20 | 92.9 | 8.5 |
| Example 1-2 | 0.95 | 52 | 49.4 | 1.35 | 16 | 91.3 | 9.2 |
| Example 1-3 | 0.95 | 2948 | 2800.6 | 0.4 | 12 | 89.6 | 9.7 |
| Example 1-4 | 0.95 | 1 | 0.95 | 1.5 | 8 | 87.6 | 11.2 |
| Example 1-5 | 0.95 | 10 | 9.5 | 1.4 | 8 | 90.5 | 9.5 |
| Example 1-6 | 0.95 | 997 | 947.15 | 1.1 | 18 | 92.0 | 8.7 |
| Example 1-7 | 0.95 | 2998 | 2848.1 | 0.4 | 9 | 88.5 | 10.4 |
| Example 1-8 | 0.7 | 398 | 278.6 | 1.25 | 16 | 91.5 | 12.8 |
| Example 1-9 | 0.75 | 397 | 297.75 | 1.25 | 19 | 92.3 | 8.6 |
| Example 1-10 | 0.97 | 396 | 392.04 | 1.25 | 17 | 91.5 | 9.2 |
| Comparative | 0.65 | 10 | 258.7 | 1.25 | 7 | 86.4 | 16.9 |
| Example 1-1 | | | | | | | |
| Comparative | 0.95 | \ | \ | 1.5 | 2 | 84.6 | 13.3 |
| Example 1-2 | | | | | | | |
| Comparative | 0.95 | 3105 | 2854.75 | 0.38 | 8 | 85.7 | 14.1 |
| Example 1-3 | | | | | | | |

From Table 1, it can be seen that in this application, controlling the mass proportion of the potassium element to satisfy 1≤b≤2998 and the sphericity of the porous carbon material to satisfy 0.7≤a≤0.97 can improve the ionic conductivity of the porous carbon material and improve both the initial coulombic efficiency and cycling swelling suppression of the secondary battery. In particular, when the relationship 50≤a×b≤2800 is satisfied, the initial coulombic efficiency and cycling swelling suppression of the secondary battery can be further improved. Specifically, in this application, controlling the sphericity to be 0.75≤a≤0.95 can balance the internal stress and contact degree of the negative electrode material, improving both the initial coulombic efficiency and cycling swelling suppression of the secondary battery. Preferably, controlling the mass proportion of the potassium element to satisfy 10≤b≤997 can further improve the ionic conductivity of the porous carbon material and improve the initial coulombic efficiency and cycling swelling suppression of the secondary battery.

### Examples 2-1 to 2-9

These examples differed from Example 1-1 only in that the mass proportion of the potassium element and the mass proportions of fluoroethylene carbonate (FEC), ethylene carbonate (EC), and ethyl sulfonyl fluoride in the electrolyte were adjusted according to Table 2. The specific adjustment parameters and performance test results were shown in Table 2 below. In addition, the content of the base solvent was adaptively adjusted, with the mass ratio of EP to PP remaining unchanged.

TABLE 2

| | Mass | | | | | | | |
|---|---|---|---|---|---|---|---|---|
| | proportion | | | | Mass | | | |
| | C of | Mass | Mass | | proportion E | | Initial | |
| | potassium | proportion | proportion | | of ethyl | | coulombic | Cycling |
| | element | D₁ of FEC | D₂ of EC | | sulfonyl | | efficiency | swelling |
| No. | (ppm) | (%) | (%) | D₁/D₂ | fluoride (%) | C/E | (%) | rate (%) |
| Example 1-1 | 14 | 9 | 12 | 0.75 | \ | \ | 88.9 | 8.5 |
| Example 2-1 | 14 | 5 | 10 | 0.50 | \ | \ | 85.6 | 9.2 |
| Example 2-2 | 14 | 20 | 10 | 2.00 | \ | \ | 84.3 | 8.4 |
| Example 2-3 | 14 | 10 | 5 | 2 | \ | \ | 87.0 | 9.3 |
| Example 2-4 | 14 | 10 | 20 | 0.5 | \ | \ | 86.2 | 8.9 |
| Example 2-5 | 14 | 15 | 10 | 1.5 | \ | \ | 89.2 | 7.8 |
| Example 2-6 | 14 | 9 | 12 | 0.75 | 0.1 | 140 | 89.6 | 7.6 |
| Example 2-7 | 14 | 9 | 12 | 0.75 | 1.4 | 10 | 91.6 | 6.8 |
| Example 2-8 | 14 | 9 | 12 | 0.75 | 0.14 | 100 | 90.7 | 7.1 |
| Example 2-9 | 1 | 9 | 12 | 0.75 | 2 | 0.5 | 90.1 | 7.5 |
| Example 2-10 | 100 | 9 | 12 | 0.75 | 1 | 100 | 90.3 | 7.4 |

From Table 2, it can be seen that in this application, controlling the electrolyte to include fluoroethylene carbonate and ethylene carbonate and controlling the mass proportions of the two to satisfy 0.5≤D₁/D₂≤2 allow the electrolyte to synergistically cooperate with the silicon-carbon material of this application, further improving the initial coulombic efficiency and swelling suppression of the secondary battery.

In particular, controlling the electrolyte to include ethyl sulfonyl fluoride and controlling the mass proportion E % of ethyl sulfonyl fluoride to satisfy 0.1≤E≤2 can further improve the initial coulombic efficiency and swelling suppression of the secondary battery. Specifically, when the mass proportion C % of the potassium element satisfies 0.5≤C/E≤100, the initial coulombic efficiency and swelling suppression of the secondary battery can be further improved.

The foregoing descriptions are merely preferred embodiments of this application and are not intended to limit this application. Any modifications, equivalent replacements, improvements, and the like made without departing from the principle of this application shall fall within the protection scope of this application.

What is claimed is:

1. A porous carbon material, wherein a sphericity of the porous carbon material is a, wherein 0.7≤a≤0.97; and
the porous carbon material comprises potassium element; and based on a mass of the porous carbon material, a mass proportion of the potassium element is b ppm, wherein 1≤b≤2998.

2. The porous carbon material according to claim 1, wherein the porous carbon material satisfies at least one of the following conditions:
$$50 \leq a \times b \leq 2800 ; \qquad ( 1 )$$
$$0.75 \leq a \leq 0.95 ; or \qquad ( 2 )$$
$$10 \leq b \leq 997 . \qquad ( 3 )$$

3. The porous carbon material according to claim 1, wherein in XRD of the porous carbon material, a full width at half maximum of a diffraction peak of a (002) crystal plane is FWHM°, wherein 0.4≤FWHM≤1.5.

4. A method of preparing the porous carbon material according to claim 1, wherein the method comprises following steps:
step S1, heating a carbon precursor in inert gas to a temperature ranging from 600° C. to 1400° C. for carbonization treatment to obtain a carbonized material, wherein a carbonization treatment duration is 2 h to 8 h, and a sphericity of the carbon precursor is 0.7 to 0.97;
step S2, mixing the carbonized material with a pore-forming agent at a mass ratio of 1:(1 to 3) to obtain a resulting mixture, then placing the resulting mixture in a rotary furnace, and heating the resulting mixture in inert gas to T° C. for activation treatment to obtain an activated material, wherein 700≤T≤1000, a duration of the activation treatment ranges from 2 h to 20 h, and the pore-forming agent comprises at least one selected from the group consisting of potassium hydroxide, potassium carbonate, potassium bicarbonate, and potassium chloride; and
step S3, sequentially washing the activated material with water and an acid solution to obtain the porous carbon material, wherein a molar concentration of hydrogen ions in the acid solution is 0.1 mol/L to 3.0 mol/L.

5. A silicon-carbon material, comprising a porous carbon material and a silicon material located within pores of the porous carbon material, wherein a sphericity of the porous carbon material is a, wherein 0.7≤a≤0.97; and
the porous carbon material comprises potassium element; and based on a mass of the porous carbon material, a mass proportion of the potassium element is b ppm, wherein 1≤b≤2998.

6. The silicon-carbon material according to claim 5, wherein the porous carbon material satisfies at least one of the following conditions:
$$50 ⩽ a \times b ⩽ 2800 ; \qquad ( 1 )$$
$$0.75 ⩽ a ⩽ 0.95 ; or \qquad ( 2 )$$
$$10 ⩽ b ⩽ 99 \; 7 . \qquad ( 3 )$$

7. The silicon-carbon material according to claim 5, wherein in XRD of the porous carbon material, a full width at half maximum of a diffraction peak of a (002) crystal plane is FWHM°, wherein 0.4≤FWHM≤1.5.

8. A secondary battery, comprising a positive electrode, a negative electrode, and an electrolyte; wherein the negative electrode comprises a negative electrode current collector and a negative electrode material layer disposed on at least one surface of the negative electrode current collector, the negative electrode material layer comprising the silicon-carbon material according to claim 5; and
based on a mass of the negative electrode material layer, a mass proportion of the potassium element is C ppm, wherein 1≤C≤100.

9. The secondary battery according to claim 8, wherein the porous carbon material satisfies at least one of the following conditions:
$$50 ⩽ a \times b ⩽ 2800 ; \qquad ( 1 )$$
$$0.75 ⩽ a ⩽ 0.95 ; or \qquad ( 2 )$$
$$10 ⩽ b ⩽ 99 \; 7 . \qquad ( 3 )$$

10. The secondary battery according to claim 8, wherein in XRD of the porous carbon material, a full width at half maximum of a diffraction peak of a (002) crystal plane is FWHM°, wherein 0.4≤FWHM≤1.5.

11. The secondary battery according to claim 8, wherein the electrolyte comprises fluoroethylene carbonate and ethylene carbonate; and based on a mass of the electrolyte, a mass proportion of fluoroethylene carbonate is D₁%, and a mass proportion of ethylene carbonate is D₂%, wherein 0.5≤D₁/D₂≤2.

12. The secondary battery according to claim 11, wherein 0.75≤D₁/D₂≤1.8.

13. The secondary battery according to claim 11, wherein 5≤D₁≤20.

14. The secondary battery according to claim 11, wherein 5≤D₂≤20.

15. The secondary battery according to claim 11, wherein the electrolyte comprises ethyl sulfonyl fluoride; and based on the mass of the electrolyte, a mass proportion of ethyl sulfonyl fluoride is E %, wherein 0.1≤E≤2.

16. The secondary battery according to claim 15, wherein 0.5≤C/E≤100.

17. An electronic apparatus, comprising the secondary battery according to claim 8.

18. The electronic apparatus according to claim 17, wherein the porous carbon material satisfies at least one of the following conditions:
$$50 ⩽ a \times b ⩽ 2800 ; \qquad ( 1 )$$
$$0.75 ⩽ a ⩽ 0.95 ; or \qquad ( 2 )$$
$$10 ⩽ b ⩽ 99 \; 7 . \qquad ( 3 )$$

19. The electronic apparatus according to claim 17, wherein the electrolyte comprises fluoroethylene carbonate and ethylene carbonate; and based on a mass of the electrolyte, a mass proportion of fluoroethylene carbonate is D₁%, and a mass proportion of ethylene carbonate is D₂%, wherein 0.5≤D₁/D₂≤2.

20. The electronic apparatus according to claim 17, wherein the electrolyte comprises ethyl sulfonyl fluoride; and based on the mass of the electrolyte, a mass proportion of ethyl sulfonyl fluoride is E %, wherein 0.1≤E≤2.
